(19) United States
(12) Patent Application Publication
(10) Pub. No.: US 2014/0017158 A1
(43) Pub. Date: Jan. 16, 2014

(54) REDUCING COST OF PARTIAL METAL REMOVAL FROM CARBIDE-DERIVED CARBON VIA AUTOMATED BATCH CHLORINE PROCESS

(71) Applicant: BAE Systems Information and Electronic Systems Integration Inc., Nashua, NH (US)

(72) Inventors: Somnath Sengupta, Ellicott City, MD (US); Robert A. Burton, Columbia, MD (US); Tadd C. Kippeny, Mount Airy, MD (US); John E. King, Ellicott City, MD (US)

(21) Appl. No.: 13/915,715

(22) Filed: Jun. 12, 2013

Related U.S. Application Data
(60) Provisional application No. 61/670,267, filed on Jul. 11, 2012.
(60) Provisional application No. 61/680,767, filed on Aug. 8, 2012.

(51) Int. Cl. C01B 31/02

(52) U.S. Cl. CPC C01B 31/02
USPC 423/445 R; 422/119; 422/111

(57) ABSTRACT

In the method of carbide-derived carbon production, wherein the improvement comprises using an automated batch chlorine process in which chlorine is added via pressure control to drive the reaction process in a closed “batch like” system.

### RELATED APPLICATIONS

This application claims the benefit of U.S. Provisional Application Nos. 61/670,267 filed Jul. 11, 2012 and 61/680,767, filed Aug. 8, 2012 which are herein incorporated by reference in their entirety for all purposes.

### FIELD OF THE INVENTION

The present invention relates to providing enhanced protection against chemical agents, toxic industrial compounds, toxic industrial materials, and other harmful volatile organic compounds and more particularly to enhanced protection in chemical respirators via increased decontamination efficiency, and reducing the production cost of carbide-derived carbon (CDC), and more particularly to system and a process for automated batch chlorine production.

### BACKGROUND OF THE INVENTION

Current materials used in chemical respirators do not provide adequate ventilation protection against select chemical agents, toxic industrial compounds, toxic industrial materials, and other harmful volatile organic compounds. Those chemicals have very low physical exposure limits yet are difficult to capture and retain in personal or collective filtration devices. This lack of performance leads to large, heavy respirator mask canisters that impede war fighter and emergency responder performance and field of view. Furthermore, the large mass and volume of current material required leads to a large pressure drop across the bed resulting in labored breathing in order to pull sufficient air through the mask for respiration.

Current carbonaceous materials or carbide derived carbon (CDC) require the addition of metals to provide adequate decontamination and protection against select chemical warfare agents (CWA), toxic industrial compounds (TIC), toxic industrial materials (TIM), and other harmful volatile organic compounds (VOC). Transition metals for catalytic degradation of agents are added to the carbonaceous material post fabrication. This process adds additional complexity, time, and cost to the preparation of current chemical respirators or gas masks.

The current process for producing CDC is through the use of a flow through system. This CDC processing system consists of three sub systems, the gas delivery system, the reaction vessel system and post process gas handling system. Gas delivery is via three mass flow controller/meters, one each for chlorine, argon and hydrogen. The mass flow controllers are connected to a four channel readout which handles the on/off and set point control for the mass flow controllers. The reaction vessel is a tube furnace with a one inch fused silica tube. Post process gasses travel through a condenser cooled to 5 degrees Celsius then exit through a gas washing bottle filled with sodium hydroxide/water solution.

The associated published process is a brute force technique. Opening the reaction gas valve to a fixed flow rate, turning on the heat, and allowing the reaction to proceed for a given time period. There are three major concerns with this process. One concern is the very small amount of material that can be processed in three hours due to the health and safely concerns associated with chlorine venting. The maximum flow of chlorine that can be vented is only 10 seem. Due to this, only 0.08 moles of chlorine can be supplied to the reactor in 180 minutes. Even if the reaction is 100% efficient, that means that only 0.04 moles (1.6 grams) of silicon carbide can be processed ever 3 hours. Another major concern is a lack of understanding how the four variables (e.g., time, temperature, gas supply rate, and byproduct re oval) affect the quality of the finished CDC product.

The final major concern is that the current cost of CDC production can range as high as approximately $30,000 per kilogram of CDC. This high cost is due to high usage of chlorine during the free flow through process and the high labor costs for cleaning scrubbers to take care of toxic byproducts. A need therefore exists for a more efficient process of producing CDC that will not only cost less, but also decrease the need for manual labor.

### SUMMARY OF THE INVENTION

The present invention offers a way to provide enhanced CWA, TIC, TIM, and VOC protection in chemical respirators via increased decontamination efficiency through a controllable increase in residual transition metal percentage and type in the carbon filter material. Target metal percentages range from 0.1-5% and metals of interest include but are not limited to copper, zinc, molybdenum, and nickel. The partial processing for removal of metals from metal carbides results in a controllable percentage of residual transition metal in the material lowering cost, delivery time, and providing increased flexibility in preparation and utility.

The present invention also allows CDC to be generated for approximately $300 per kilogram of CDC which represents a reduction of approximately two orders of magnitude over the current price. The CDC is produced in a closed furnace-batch system in which chlorine is added via pressure control to drive the reaction process in a closed “batch like” system. At completion, which means no more pressure changes are occurring, the remaining viable chlorine is collected and recycled and/or released such that most, if not all, chlorine is used and little to no scrubbing is required.

Those skilled in the art will appreciate that the present invention provides a method to mediate the high costs associated with chlorine use and high labor. Processing CDC with this type of system is preferable because there is almost no waste of chlorine. Only a small amount is sent to the scrubber at the beginning and at the end of the process and the reaction only consumes what is needed. Additionally, by condensing the byproducts they can be collected and not sent to the scrubber.

### BRIEF DESCRIPTION OF DRAWINGS

The present invention is further described with reference to the following drawings wherein:

FIG. 1 is a closed furnace batch system for CDC processing.

FIG. 2 is a closer look at the process gas loop of the closed furnace batch system.

FIG. 3 is a vertical closed furnace batch system for CDC processing.

FIG. 4 is a graph showing a 99% conversion from silicon carbide to CDC;

FIG. 5 is a graph from a gas sorption analysis displaying the surface area of samples processed at varying lengths of time;

FIG. 6 is a graph from a thermo gravimetric analysis displaying the weight loss of samples processed at varying lengths of time;

FIG. 7 is a graph displaying a one minute data snapshot of chlorine being dosed to maintain 0.7 psi in the reactor; and

FIG. 8 is a graph displaying chlorine consumption during a 9 hour process.

### DETAILED DESCRIPTION

One aspect of the current invention includes modifications for the process to make various derivations of partially converted to fully converted CDC as desired. The invention allows chlorine to be delivered to the reactor as needed and for the reaction byproducts to be condensed out of the system. These embodiments have resulted in a 75% reduction in chlorine usage over process conditions used in the prior art.

The present invention is further defined in the following embodiments:

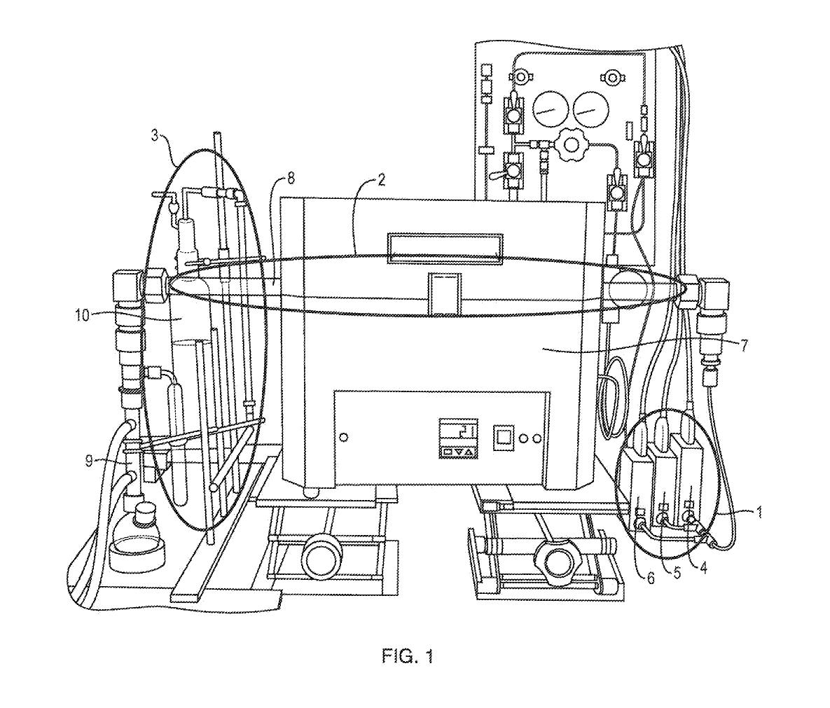

Referring to FIG. 1, one embodiment has some similarities with the published CDC processing system consisting of three sub systems: the gas delivery system 1, the reaction vessel system 2 and post process gas handling system 3. Gas delivery is via three MKS mass flow controller/meters: one each for chlorine 4, argon 5, and hydrogen 6. The mass flow controllers are connected to a MKS 247D four channel readout which handles the on/off and set point control for the mass flow controllers. The reaction vessel 2 uses a Thermo Scientific, 1100 degree Celsius, tube furnace 7 with a one inch fused silica tube 8. Post process gasses travel through a Liebig type condenser 9 cooled to 5 degrees Celsius then exit through a gas washing bottle 10 filled with sodium hydroxide/water solution.

However, in this embodiment, the closed furnace batch system, facilitating process refinement and control, incorporates two additional subsystems: a closed (low pressure) process gas system 11 and a data logging/process control system. Closing the process gas loop requires a high accuracy relief valve be installed on the gas exit side of the reactor creating a slightly positive pressure in the system (0.5-5 psi). On the gas inlet side a high accuracy pressure regulator or the mass flow controllers 4 will dose the reactant gas as needed. A 10 liter per minute diaphragm pump in the positive pressure loop will provide increased gas flow through the reaction vessel 2. Data logging and process control will be provided by a pressure transducer in the positive pressure gas loop, the three mass flow meters 4, 5, 6, a temperature transducer at the reaction tube 12, a current transducer 13 on the furnace power cable, an eight channel multi function data acquisition device and a laptop running Labview graphical programming language.

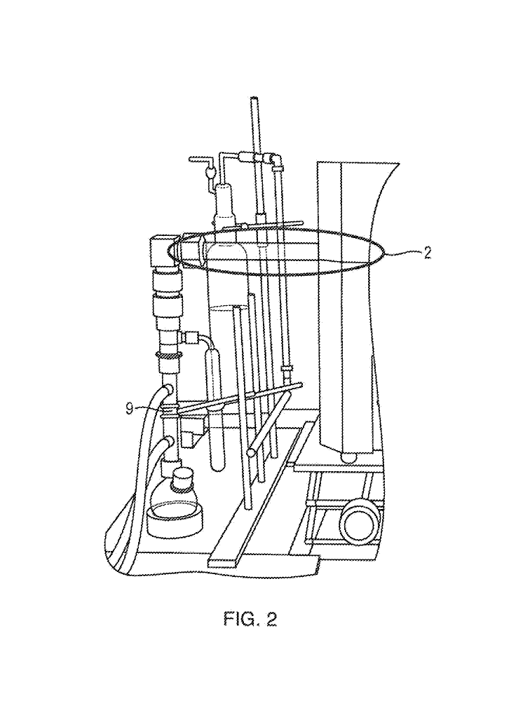

Referring to FIG. 2, a closer look at the closed process gas loop of the closed furnace batch system shown in FIG. 1. Instead of allowing the gas to flow in freely, reaction gas is fed into the loop by a precision regulator or mass flow controller 4. The reaction gas then cycles through the reaction vessel 2 through the condenser 9 through the diaphragm pump and back to the reaction vessel 2. Gas exiting the loop is then controlled by a precision relief valve. Pressure in the loop is monitored by precision low pressure transducer. The circulating flow provided by the diaphragm pump can be regulated by a valve or restrictor orifice.

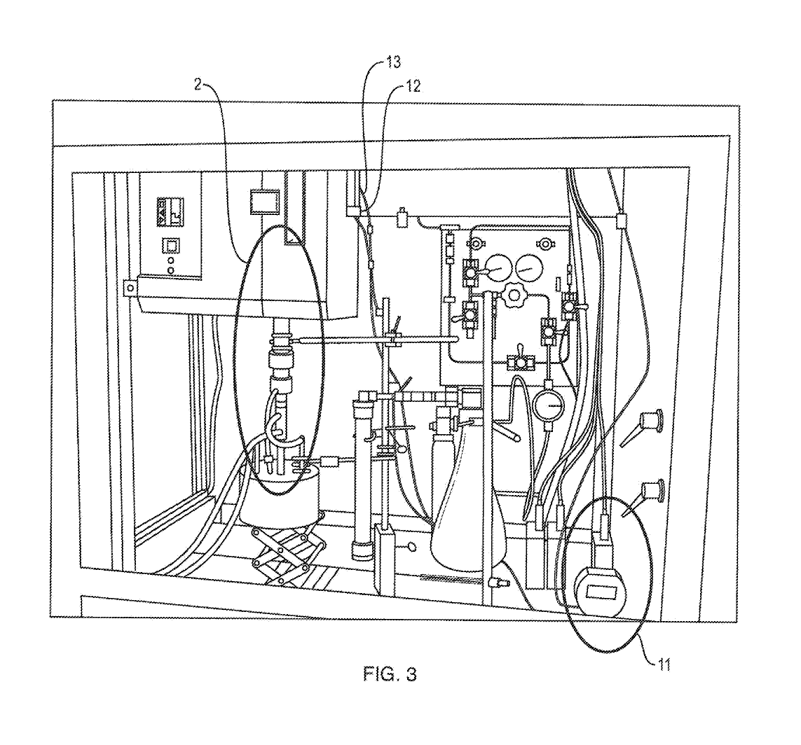

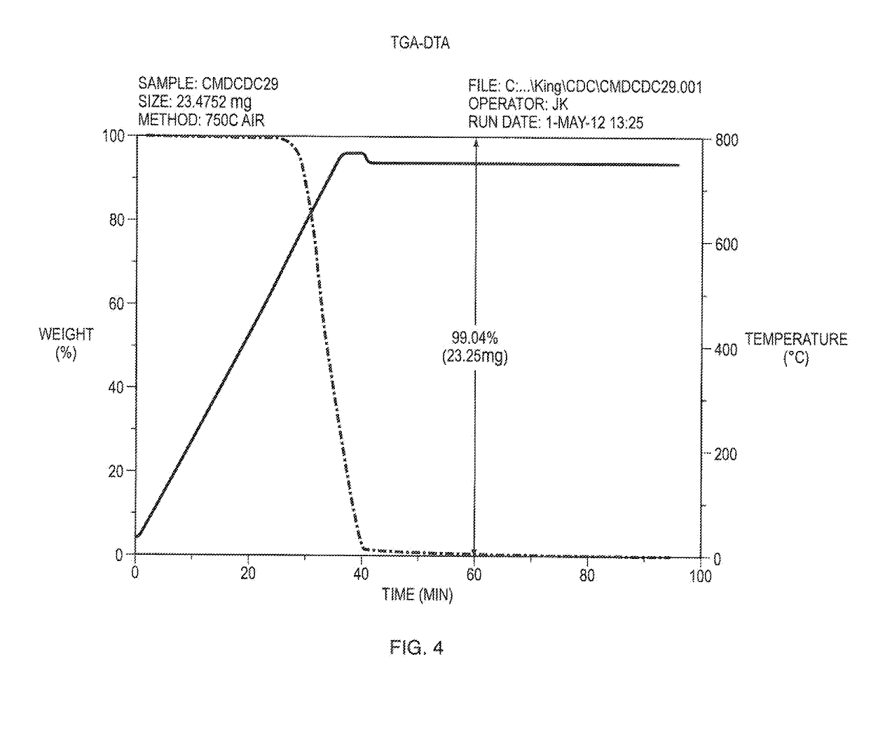

Referring to FIG. 3, another embodiment of the invention changes the orientation of the 25 g reaction vessel 2 from horizontal to vertical. Problems with the horizontal orientation included: build-up of condensable reaction byproducts, poor loading efficiency, and poor utilization of the fume hood space. With the reactor oriented vertically, condensed byproducts now drain completely out of the tube into the collection vessel. The maximum load of silicon carbide has increased from 20 g to 100 g and fume hood space is being utilized much more efficiently. Referring to FIG. 4, initial 20 g test runs of Silicon carbide have resulted in a 99% conversion to CDC. Test runs of 40 g and 100 g have also been completed successfully.

The product has been characterized by TGA. This configuration may be scaled up beyond 100 g if required. TGA data indicates a 93-98% conversion from starting material to this embodiments' sorbent material for all sampling locations taken at various points along the SiC reactant bed. Of interest is that the ‘top’ portion of the reactant column has the lowest processed conversion of 93% while the ‘bottom’ of the column (product exit) is the most converted at 98%. The current working theory is that the reaction is fundamentally controlled by the product generation and thus removal is critical to full conversion. Thus near full conversion at the exit, where the products can easily escape and poorer conversion at the chlorine inlet where the unwanted products must traverse a fully loaded column to escape. Further, all isotherms compiled from the gas sorption data are type I and indicate highly micro porous samples as properly synthesized CDC should be. BET surface area data also reveals a trend of higher surface area at the top of the reactor to lower surface area at the bottom of the reactor which is suspected to be caused by insufficient scrubbing of byproducts. So although the material synthesized at the bottom of the bed measures with less surface area, it is strongly suspected that the reduction is due to clogged pores from reaction byproduct.

In one embodiment, a small amount of silicon carbide (<1 g) in a quartz crucible is placed inside the reaction tube. Flow of ultra high purity grade argon is started. As the reaction tube is purged with argon, the temperature is raised to the reaction temperature (900-1100 degrees Celsius.) After 30 to 60 minutes the reaction vessel is purged and the temperature stable. Argon flow is stopped and a 10 sccm flow of chlorine is started and continued for 180 minutes. Upon completion of the chlorine etch process the gas flow is switched back to argon and the reaction vessel is allowed to cool. Samples are then removed for analyses or subjected to an additional treatment in hydrogen at 600 degrees Celsius for 120 minutes to remove residual chlorine. Post process gasses, chlorine, silicon tetrachloride, hydrogen and argon, first pass through the condenser, where the silicon tetrachloride will be collected, then through the gas washing bottle where the chlorine will be removed by the sodium hydroxide/water solution.

The present invention is further defined by the following working examples:

### Example 1

In this working example, the relief valve is set to 2 psi. The pressure for the loop is set at 1.5 psi by the control software. As the reaction proceeds, the silicon and chlorine react forming silicon tetrachloride. The silicon tetrachloride has a boiling point of 60 degrees Celsius, it will condense out of the gas stream in the Liebig type condenser that is cooled to 5 degrees Celsius. This will lower the pressure in the loop. The pressure transducer will report a loop pressure less than 1.5 psi to the control software. The control software will then command the mass flow controller to add reaction gas to the loop until the pressure is greater than or equal to 1.5 psi. Gas will not exit the loop unless the pressure exceeds 2 psi. The diaphragm pump will constantly circulate the gases in the loop helping to purge the reaction zone of byproducts that may slow the reaction, This embodiment allows as much gas as is required by the reaction to be feed into the loop. For example, if the reaction zone length is 152 mm (approx. 6 inches) and a packing density of 50%, you may process up to 100 grains of silicon carbide in 180 minutes by simply filling the reaction zone with silicon carbide. The only gas that needs to be vented is the small volume remaining in the process tube when the process is complete.

### Example 2

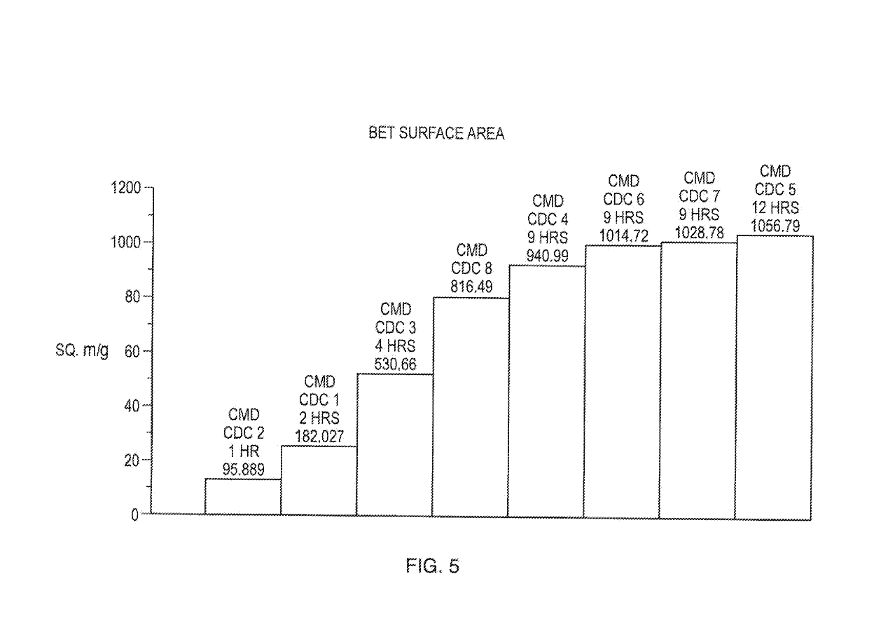

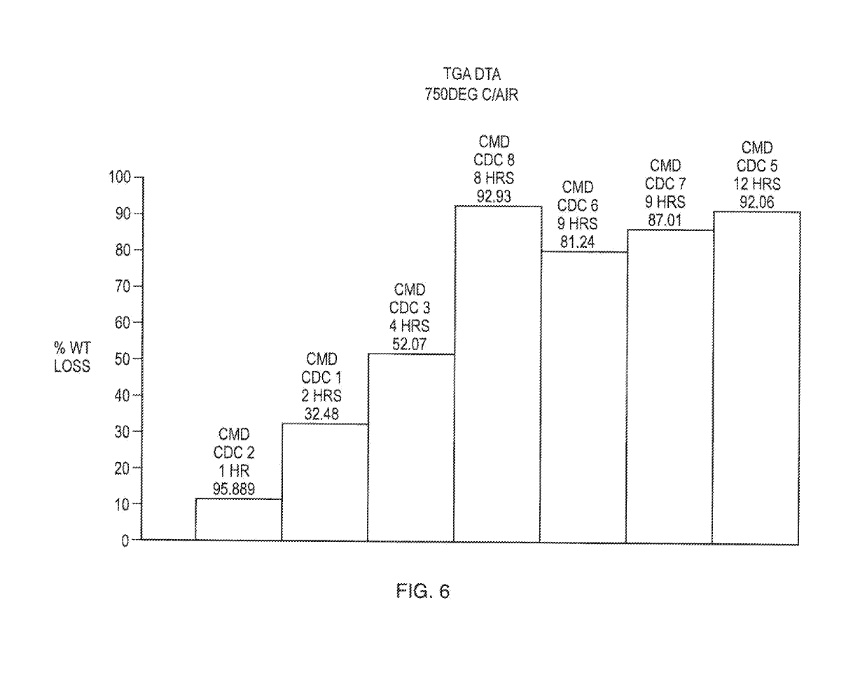

Referring to FIGS. 5 and 6 gas sorption and thermo gravimetric analysis of one embodiment processed for 9 or more hours had a surface area range of 900-1100 sq.m/g and a weight loss 82-92%. In this embodiment, 1 g samples of silicon carbide were processed at 1000 degrees Celsius and a 10 sccm flow of chlorine. Process time was varied from 1 hour to 12 hours. All samples were further processed in a 600 degree hydrogen atmosphere for 2 hours. Selected samples were evaluated by the “Chem Scout” program for their gas adsorption or desorption behavior. General adsorption or desorption behavior was reported to be very good (e.g., a 3× improvement with methyl carbamate and 5× improvement with nitrophenol).

One embodiment presents modifications to the prior art process by allowing chlorine to be added as needed by the reaction. In this embodiment, the software is allowed to monitor and control chlorine flow resulting in a reduction in chlorine usage, from 5.4 liters per gram of silicon carbide processed to 1.2 liters per gram of silicon carbide processed. Sample # CMD CDC 8 was processed in this manner for 8 hours. As can be seen in FIGS. 5 and 6, this sample has a surface area of 816 sq.m./g and greater than 90% conversion to CDC.

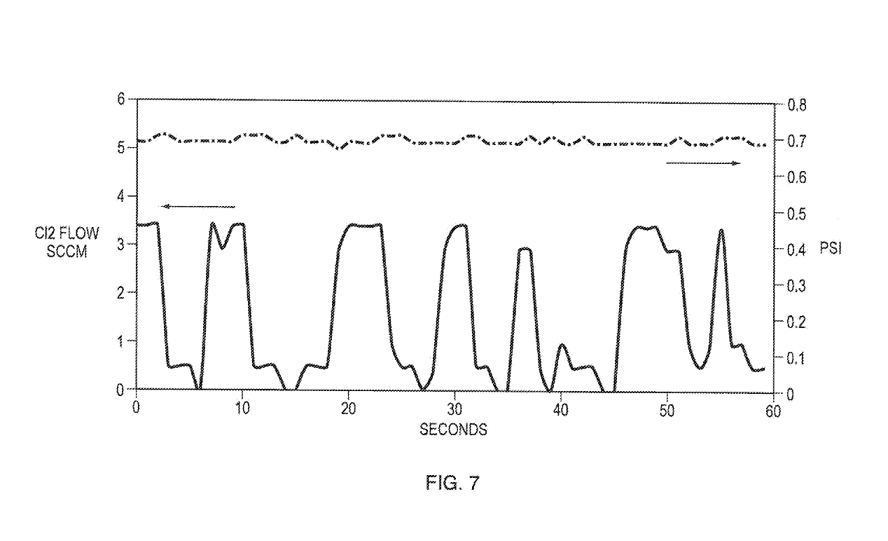

FIG. 7 shows another aspect of this embodiment showing a 1 minute snapshot of data recorded during a software controlled experiment. The blue trace in FIG. 3 is the mass flow controller dosing chlorine to maintain a 0.7 psi reactor pressure. During the process, chlorine is consumed and reaction byproducts condensed out; both have the effect of dropping the pressure in the reactor below a setpoint. The software will detect very small drops in pressure and add chlorine as needed.

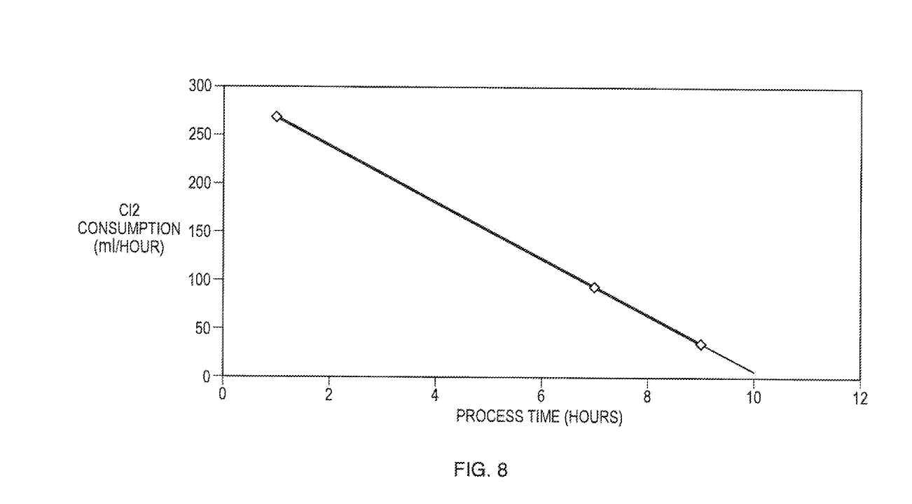

Referring to FIG. 8 is a plot of flow rates derived from one minute snapshots during the first, seventh, and ninth hours of the process. There is a gradual decline in the amount of chlorine consumed as the reaction proceeds towards completion. Forecasting the trend indicates process completion at 10 hours; this is in close agreement with the BET surface area and TGA DTA data.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method of carbide-derived carbon production comprising
processing a silicon carbide;
adding a chlorine flow to a reactor;
monitoring said chlorine flow; and
controlling said chlorine flow.

2. The method of claim 1 further comprising the steps of:
collecting an excess amount of chlorine with a cold trap; and
recycling said excess amount of chlorine.

3. The method of claim 1 wherein processing a silicon carbide is performed at a temperature of about 1000 degrees Celsius for a time;

4. The method of claim 1 wherein processing a silicon carbide is performed pressure of about 600 degree hydrogen atmosphere.

5. The method of claim 1 further comprising processing a silicon carbide for a second time.

6. The method of claim 1 wherein a time is from about one hour to about ten hours as desired.

7. The method of claim 1 wherein adding a chlorine flow is done through pressure control.

8. The method of claim 1 further comprising the step of maintaining a reactor pressure of 0.7 psi.

9. A method of carbide-derived carbon production comprising:
adding an amount of silicon carbide to a pressurized furnace;
processing said amount of silicon carbide;
adding a chlorine flow to said pressurized furnace;
maintaining a constant pressure;
monitoring said chlorine flow;
controlling said chlorine flow;
collecting an amount of silicon tetrachloride with a cold trap;
collecting an amount of excess chlorine; and
recycling said amount of excess chlorine.

10. The method of claim 9 wherein processing said amount of silicon carbide is performed at a temperature of about 1000 degrees Celsius.

11. The method of claim 9 wherein processing said amount of silicon carbide is performed at a pressure of about 600 degree hydrogen atmosphere.

12. A system for producing carbide derived carbon comprising:
a closed process gas system;
a pressurized furnace connected to the closed process gas system;
a cold trap connected to the pressurized furnace opposite the pressure monitor; and
a recycle tank connected to the cold trap opposite the pressurized furnace.

13. The system of claim 12 wherein the closed process gas system comprises:
a chlorine tank connected to a pressure monitor;
a data logging and process control system connected to the pressure monitor; and
a mass flow controller, where the mass flow controller is connected to the data logging and process control system and connects the chlorine tank to the pressurized furnace,

14. The system of claim 12 wherein the mass flow controller doses said pressurized furnace with chlorine to maintain a 0.7 psi reactor pressure.

15. The system of claim 12 further comprising:
a cold trap connected to the pressurized furnace opposite the pressure monitor; and
a recycle tank connected to the cold trap opposite the pressurized furnace.
